(19) United States
(12) Patent Application Publication
(10) Pub. No.: US 2026/0274693 A1
(43) Pub. Date: Sep. 17, 2026

(54) METHOD OF PRODUCING ALKALI METAL SILICATE WITH REDUCED METAL LEVELS

(71) Applicant: Evonik Operations GmbH, Essen (DE)

(72) Inventors: Eric G. Lundquist, Essex, MD (US); Duenwu Hua, Edgewood, MD (US)

(73) Assignee: Evonik Operations GmbH, Essen (DE)

(21) Appl. No.: 19/480,055

(22) PCT Filed: Apr. 23, 2024
(86) PCT No.: PCT/EP2024/061005

§ 371 Date: Oct. 30, 2025

(30) Foreign Application Priority Data
May 3, 2023 (EP) 23171323.1

(51) Int. Cl. C01B 33/32; C01B 33/193

(52) U.S. Cl. CPC C01B 33/325; C01B 33/193

(57) ABSTRACT

The present invention relates to method of producing alkali metal silicates with reduced heavy metals in a high temperature furnace fusion process by use of sustainable waste or recycled sand sources. The invention also relates to use of waste, used or recycled (e.g; waste foundry sand) either alone or blended with virgin sand for producing the alkali metal silicate.

### TECHNICAL FIELD OF THE INVENTION

The present invention relates to a method of producing alkali metal silicates by removal of heavy metals from the alkali metal silicate during high temperature furnace fusion process by use of sustainable silica sources. The invention also relates to use of waste, used or recycled sand (e.g.; waste foundry sand) either alone or blended with virgin sand for producing the alkali metal silicate.

### BACKGROUND OF THE INVENTION

The present invention relates to the field of alkali metal silicate production by use of waste or recycled sand under a high temperature furnace fusion process.

In recent years, there has been a growing interest in using sustainable raw materials in alkali metal silicate production. These sustainable silica sources will safeguard the ecosystem, environmental assets and sustainable supply.

It is therefore an object of the present invention to provide a sustainable silica source for alkali metal silicate production.

Precipitated silicas are typically produced by the reaction of an alkali metal silicate solution e.g. sodium silicate, with a mineral acid such as sulfuric acid. The acid and the sodium silicate solution are added together with agitation to water. The precipitation occurs and the precipitated silica is recovered by filtration, washed of residual sodium sulfate and dried.

The key material used in producing precipitated silica are alkali metal silicates such as; sodium silicate. Sodium silicate can be produced by either the reaction of sand with aqueous caustic (hydrothermal) or by a furnace process in which sand is reacted with sodium carbonate at temperatures greater than 1000° C. Both processes utilize sand as a key raw material. Sand although one of the most abundant materials on earth is mined and is thus not considered a sustainable material.

Moreover, for the purpose of producing alkali metal silicates (such as; sodium silicate), it has been known that removal of significant amounts of such heavy metals is necessary to comply with certain regulatory requirements of the final precipitated silica. The alkali silicate material is required to exhibit low level of heavy metal contamination.

Hereby is provided a new sustainable source and production method for producing alkali metal silicates from raw materials known to exhibit elevated amounts of heavy metals.

It has been found that recycled or waste sand can be used as a sustainable raw material in a high temperature furnace process to produce alkali metal silicates with reduced metal levels

The sustainable waste foundry sand (WFS) is the by-product of the foundry and metal casting industry.

Approximately 100 million tons of WFS is generated worldwide by the foundry industry in each year. According to EC regulations, as stated in “Hinghofer-Szalkay D., Koch B. A. European Tort Law 2008. Springer; Berlin/Heidelberg, Germany: 2009, European Union; pp. 647-657”, WFS is classified as non-hazardous waste also because even if the total metal concentrations in waste sands are increased with respect to virgin sand, it remains generally low.

It has been known and proved with the scientific studies that the WFS is a classified as a sustainable source in concrete production instead of natural river sand.

In regular foundry processes, foundry sand refers to clean, uniformly sized, high quality silica sand that is used in the casting process. Sand is bonded to form molds, cores or patterns which are used to make ferrous or non-ferrous metal castings.

Foundries successfully recycle and reuse the sand many times in a foundry. When the sand can no longer be reused in the foundry, it is removed from the foundry and is regarded as waste foundry sand (WFS) or used foundry sand (UFS) or spent foundry sand (SFS) or even recycled foundry sand. In the present invention waste sand (especially WFS) term is used for consistency, but not limited to any sustainable recycled, waste or used sand specifically.

There are studies about characterizing the physical and chemical composition of WFS, fresh properties, mechanical and durability performance especially in use of concrete. These characteristics can vary quite a bit from one foundry to another.

In last few decades, several studies have been conducted to investigate the effect of addition of waste foundry sand as partial and complete replacement of regular sand in concrete.

It is well known in the art the use of furnace process while producing alkali metal silicates, especially sodium silicates, by use of high temperatures and managing the stoichiometric amounts of sand and caustic to perform well. One of those well-known examples can be found in EP 1 787 960 A1 patent publication from HUBER CORP.

There has been publications regarding properties and use of WFS, however most are about mortar, cement, concrete or other building materials preparation or processing.

The co-processing method of sand grained waste incineration fly ash in cement kiln is proposed in CN 111732353 A.

The other mentions utilizing the spent waterglass for foundry applications, as described in CN 103143672 A. The application discloses a method for preparing water glass that is utilized for foundry application.

Another patent application WO 2015/187778 A1, also discloses the stabilization of at least one heavy metal contained in a sodic fly ash using a water-soluble source of silicate and a material containing calcium and/or magnesium.

One another article from MOHAMED ISMAIL ABDUL ALEEM ET AL; published on Journal of Cleaner Production, Elsevier Amsterdam NL, vol. 264, 18 Apr. 2020 XP086164598, ISSN: 0959-6526, DOI:

10.1016/J.JCLEPRO.2020.121689; covers the treatment of spent foundry sand to be used as a source for sodium silicate synthesis. But this article specifically focuses on removal of phenolic carbon and metal impurities prior to hydrothermal process by subjecting the spent foundry sand to calcination followed by bleaching which would require a lot of additional energy.

In the Indian patent application IN 201941026558, a process for the production of alkali metal silicates from spent foundry sand via a hydrothermal method at temperatures between 150 and 300 C is disclosed.

None of the prior art disclosures disclose the use of WFS for alkali metal silicate production by use of furnace fusion process which utilizes high temperatures and results with low metal levels and high molar ratio of silica with ease of filtering to remove the insoluble metal impurities.

Accordingly, there is a need to find a sustainable source for alkali metal silicate production under suitable process conditions which leads less waste and high molar ratio of silica/alkali metal.

### SUMMARY OF THE INVENTION

It is an advantage of the present invention to provide a sustainable silica source for alkali metal silicate production with reduced metal levels that can be filtered easily.

After precise investigations, the inventors of the present invention have surprisingly found that by use of waste or recycled sand (e.g.: waste foundry sand) in a furnace process for production alkali metal silicate(s) as defined in claim 1, solves the above technical problem as it provides a sustainable silica source for alkali silicate production, creates less waste and allows production of high molar ratio of silica/alkali metals with reduced heavy metal levels.

Advantageously, the use of waste or recycled sand provides for a favorable environmental impact in the sustainable reuse of a material.

According to a first aspect, the invention relates to a method of producing an alkali metal silicate material (water glass) by use of waste sand either alone or in combination with virgin sand (e.g.: waste foundry sand or mixtures thereof with virgin sand) via furnace process as defined in claim 1.

A second aspect of the present invention is; use of waste or recycled sand, as the sustainable silica source (or raw material), for producing an alkali metal silicate with reduced level of heavy metals.

A third aspect of the invention is use of alkali metal silicate (waterglass), being produced by use of waste sand by a furnace process in which sand is reacted with sodium carbonate at temperatures greater than 1000° C. as defined in claim 1, for production of precipitated silica.

The present invention provides for a direct process in the solid state by use of furnace method at elevated temperatures to produce alkali metal silicate, in particular sodium silicate that can be dissolved and filtered without issues providing aqueous solutions of sodium silicate with improved color and reduced metals.

It is an advantage of the present invention to provide a sustainable source for alkali metal silicate production with reduced level of heavy metals. It has been found that utilizing phosphate containing waste sand either alone or blended with virgin sand and then reacted with sodium carbonate in a high temperature furnace fusion process produces, when dissolved in water and filtered, aqueous sodium silicate solutions with reduced metal content. Alternatively, phosphates such as sodium phosphate or sodium tripolyphosphate can be added to waste foundry sand or virgin sand to create the silicon dioxide raw material such as the WFS with a phosphorus level of greater than 30 ppm.

In the present invention, a furnace fusion process is being used to convert the phosphate containing waste or recycled sand into a solid alkali silicate material. It is believed that during this high temperature reaction of sand with a caustic material (e.g.: sodium hydroxide, sodium carbonate), the phosphate reacts with various metal impurities forming insoluble metal phosphate complexes that can be easily filtered away when the solid sodium silicate waterglass is dissolved in water to make aqueous sodium silicate solutions.

Accordingly, it is an advantage of the present invention to provide a sustainable silica source (e.g.: waste foundry sand), with significantly improved method of removing substantial amounts of undesirable heavy metal contaminates from alkali metal silicate materials.

The additional advantage of the present invention is the ease of filtration compared to the known methods for metals removal including that firstly disclosed in U.S. Pat. No. 7,297,318 B2 where calcium phosphates are used to treat aqueous solutions of metal silicates. Although the process is effective in complexing metals, the insoluble heavy metal complexes formed are difficult to filter. The present invention in which the phosphates react with the heavy metal impurities in the sand during the solid phase furnace process provides a solution once dissolved in water that is easy to filter.

### BRIEF DESCRIPTION OF THE DRAWING

For the purpose of better illustrating the advantages and properties of the claimed alkali metal silicate composition, object of the present invention, below Figures has been disclosed with the invention submission.

FIG. 1 is a picture showing sodium silicate solution being produced via hydrothermal process by use of a mixture of waste sand and virgin sand.

FIG. 2 is a picture showing sodium silicate solution being produced via furnace process by use of a mixture of waste sand and virgin sand.

FIG. 3 is providing the analytical data showing the visible range absorbance of the sodium silicate solution being produced via furnace process comparing to the sodium silicate solution being produced via hydrothermal process.

### DETAILED DESCRIPTION OF THE INVENTION

Commercially, alkali metal silicates are prepared by two general methods which are the hydrothermal method (liquid) and the furnace method (solid waterglass). The silica source (quartz) used is typically a small particle sized sand. The alkali metal may be sodium, potassium or lithium, with sodium preferred.

In the hydrothermal method, the hydrothermal reaction of sand (quartz) with aqueous caustic, (e.g.: sodium hydroxide or potassium hydroxide) takes place at temperatures between 150 C and 250 C. In this method, excess sand, caustic and water are agitated in a pressure reactor and the unreacted sand is then separated from the formed sodium silicate solution by filtration. The resulting molar ratio is generally between 2.5 and 2.8 (SiO₂/Na).

In the furnace method, sand (quartz) and a base (such as; sodium carbonate or sodium hydroxide) are reacting together at high temperatures. In this method, the solid silicate waterglass is produced by heating stoichiometric amounts of sand and sodium carbonate (Na₂CO₃) up to 1100° C. to about 1400° C. in a gas-fired furnace or electric or plasma furnace. The formed waterglass is cooled, crushed and dissolved in water to form the liquid sodium silicate solution with a molar ratio of between 3.0 and 3.8 molar ratio (SiO₂/Na). The solubilized silicate solution is then filtered by filtration to remove the non-soluble heavy metal complexes and unreacted sand.

In both methods, the mixture is filtered to remove unreacted sand and any other insoluble species.

Insoluble heavy metal complexes and/or salts are removed from alkali metal silicate mixture by filtration, centrifugation, or vibrating screening, preferably by filtration, such as pressure leaf filtration. Pressure leaf filtration is the preferable filtration method.

According to the present invention, it is preferred to use the furnace method to produce alkali metal silicate (waterglass) due to its advantages of providing higher molar ratio (SiO₂/Na) and ease of filtration.

It is believed that at high temperatures (at temperatures greater than 1000° C.), phosphate reacts with metal impurities to form the metal phosphate complexes which are not water soluble and are easy to filter away.

Thus, the present invention encompasses a method of producing an alkali metal silicate material comprising the steps of:
a) providing a silicon dioxide source or mixtures thereof,
b) mixing said silicon dioxide source with an alkali base,
c) heating the mixture at a temperature above 1000° C. for 1-5 hours
d) dissolving furnace waterglass in water and
e) removing any resultant insoluble heavy metal complexes and/or salts from said alkali metal silicate mixture,
wherein the silicon dioxide source is a waste sand or mixtures thereof or a mixture of waste sand with virgin sand.

Another aspect of the present invention is the use of waste sand as a sustainable source for alkali metal silicate production.

Yet another aspect of the invention is the use of alkali metal silicate being produced by use of waste sand by a furnace process in which sand is reacted with sodium carbonate at temperatures greater than 1000° C., for production of precipitated silica.

According to the present invention, it is preferred that the waste sand is a phosphate containing waste sand, preferably waste foundry sand (WFS) that comprises phosphate in it.

According to the present invention, it is preferred that the base is a metal carbonate such as sodium, potassium or lithium, preferably sodium carbonate (named as soda ash) or is a hydroxide, preferably sodium hydroxide.

According to the present invention, it is preferred that said waste sand is introduced to said base to create a solid sodium silicate in an molar ratio between 3.0 and 3.8.

According to a preferred embodiment, waste/recycled sand (e.g.: WFS) or combinations thereof is being used as the silicon dioxide source alone.

According to a preferred embodiment, waste/recycled sand (e.g: WFS) is being mixed with virgin sand.

According to a preferred embodiment, waste sand is introduced to virgin sand in an amount from 20 wt. % to 80 wt. % based on the total weight of the sand.

According to the invention additional phosphate source can be added to waste foundry sand or virgin sand to create the silicon dioxide raw material with a phosphorus level of greater than 30 ppm. Phosphate source is selected from the group consisting of hydroxyapatite, dicalcium phosphate, tricalcium phosphate, STTP hydroxyapatite preferably sodium phosphate or sodium tripolyphosphate and any mixtures thereof.

According to the invention the mixture of the silicon dioxide source and caustic is heated to a temperature between 1000° C. to 1400° C., preferably between 1100° C. to 1400 and most preferably 1150° C. to 1200° C. for 1-5 hours, preferably 1-3 hours and more preferably 1.5 to 2 hours.

According to the present invention the waterglass is made through a fusion process at very high temperature (1100-1200, preferably 1150° C.), the reaction carried by melting the sand and soda ash solids together as shown with the chemical equation below;

SiO₂ (s)+Na₂CO₃ (s)Δ→Na₂SiO₃(s)+CO₂ (g)

The main advantage of the present invention is use of a sustainable silica source for alkali metal silicate production.

Another advantage of the present invention is reducing metal levels in alkali metal silicate (e.g: sodium silicate) by use of phosphate containing waste sand by applying furnace process at temperatures greater than 1000° C.

Yet another advantage of the present invention vs. the previous known methods is the ease of filtration. The alkali metal silicate produced via the furnace process after dissolution in water is easily filtered to remove insoluble heavy metal complexes and/or slags from the alkali metal silicate mixture.

The alkali metal silicate (waterglass) can be used as such, as an ingredient in finished formulations or as a raw material to prepare precipitated silica, silica gel, calcium silicate, magnesium silicate, sodium aluminosilicate, and sodium magnesium aluminosilicate, and the like, which meet food, cosmetic and pharmaceutical requirements for trace metal contaminant levels.

The alkali metal silicate being produced according to the present invention is the main source for producing precipitated silica.

Precipitated silicas are utilized in key applications such as toothpaste, cosmetics, food and rubber tires. In these applications, silica provides unique and meaningful benefits and cannot be easily replaced. End use formulations include many different personal care preparations, such as dentifrices, cosmetic compositions, such as body powders, and the like, and other like applications, such as anti-caking and/or free-flowing agents that necessarily require human consumption or food contact, such as paper, plastic and rubber fillers, and pharmaceutical excipients for proper utilization thereof. Such materials that form much of the basis of these end use formulations are produced from silicon dioxide sources of various levels of heavy metal contamination. The most expensive silicon dioxide sources are considered the most pure in terms of such levels of heavy metal presence and thus generally do not require any modification to reduce potential toxic effects that may result therefrom. However, as the necessity for lower costs for source materials increases, and/or the source of pure silicon dioxide materials becomes rarer, it has thus become important to provide some manner of reducing the amount of heavy metals present within either such starting materials or, more particularly, within intermediate materials produced therefrom.

Precipitated silicas are basically produced via the initial production of metal silicates (such as, without limitation, sodium silicate) and then exposing such a material to a mineral acid (sulfuric acid, as one example), and subsequently precipitating the resultant silica produced thereby. Silica gels may also be formed through reaction of sodium silicate with acid under different conditions. In essence, it has been realized that the ability to reduce the amount of heavy metals within such ultimate products may be addressed during one of the process steps for producing the needed metal alkali silicate intermediate material.

Metals, such as lead, calcium, nickel, manganese, chromium, arsenic, cadmium, copper, iron and zinc when present as impurities in precipitated silica can not only provide potential toxicity in food applications but can also interfere with curing chemistries when the silica is used rubber tire vulcanization processes. Heavy metals, such as lead, arsenic, cadmium, copper, and zinc, exhibit differing levels of toxicity within mammals. Particularly when ingested and in a state that can be metabolized and absorbed in the body, i.e., when it is ingested in a bioavailable form, such metals exhibit a propensity for toxic effects, even in low amounts, and upon accumulation within the body. As a result, regulatory agencies at both the state and federal levels have enacted regulations in terms of the maximum amount of such heavy metals that are generally permitted within materials that have the potential for human consumption. Thus, it is important to develop methods for minimizing the amount of such heavy metals within materials that may be utilized and ingested by humans (and other mammals).

Phosphate materials have been suggested as possible additives to remove certain heavy metals, such as lead, from aqueous solutions wherein virgin sand has been used as the silica source, as being disclosed in U.S. Pat. No. 7,297,318 B2, but not from solid materials. Therefore, although use of phosphate and calcium phosphate materials for immobilizing lead and heavy metals has been suggested in the prior art, there has been no prior disclosure of a method for accomplishing immobilization of lead or other heavy metals from the high temperature reaction of sand and sodium carbonate in a furnace fusion process wherein waste sand is being used as the silicon dioxide source

### Preferred Embodiments of the Invention

Present invention provides a method of producing an alkali metal silicate material comprising the steps of:
a) providing a silicon dioxide source or mixtures thereof,
b) mixing said silicon dioxide source with an alkali base,
c) heating the mixture at a temperature above 1000° C. for 1-5 hours
d) dissolving resulting solid sodium silicate waterglass in water and
e) removing any resultant insoluble heavy metal complexes and/or salts from said alkali metal silicate mixture,
wherein the silicon dioxide source is a waste sustainable sand or mixtures thereof or a mixture of waste sand with virgin sand.

According to a preferred embodiment, said waste sand is a phosphate containing waste sand, preferably waste foundry sand with a phosphorus level greater than 20 ppm, preferably 25 ppm.

According to a preferred embodiment, said alkali base is a metal carbonate selected from sodium, potassium or lithium, preferably sodium carbonate or is a hydroxide, preferably sodium hydroxide.

According to a preferred embodiment, said waste sand is introduced to said alkali base to create a solid sodium silicate with a molar ratio between 3.0 and 3.8.

According to another preferred embodiment, said waste sand is introduced to virgin sand in an amount from 20 wt. % to 80 wt. % based on the total weight of the sand wherein the sand mixture comprises 20 wt. % to 50 wt % of phosphate containing waste sand and 50 wt % to 80 wt. % of virgin sand based on the total weight of the sand According to a preferred embodiment, said silicon dioxide source and base mixture is heated to a temperature between 1000° C. to 1400° C. for 1-3 hours.

According to a preferred embodiment the present invention provides a method of producing an alkali metal silicate material comprising the steps of:
a) providing phosphate containing waste sand as an silicon dioxide source or mixtures thereof or in combination with virgin sand,
b) mixing said waste sand with a sodium carbonate
c) heating the mixture at a temperature of 1150° C. for 1.5 to 2 hours
d) dissolving resulting solid sodium silicate waterglass in water and
d) removing any resultant insoluble heavy metal complexes and/or salts from said alkali metal silicate mixture
wherein the phosphate containing waste sand is waste foundry sand (WFS).

According to a preferred embodiment, the present invention provides use of waste sand in particular waste foundry sand as a sustainable source for alkali metal silicate production.

According to a preferred embodiment, the present invention provides a method of producing precipitated silica by use of alkali metal silicate material being produced by use of waste foundry sand either alone or in combination with virgin sand via furnace process.

According to another embodiment of the present invention provides a method of producing precipitated silica comprising the steps of;
a) providing an alkaline silicate solution comprising an alkaline silicate and water
b) Mixing the alkaline silicate solution with a mineral acid and agitation.
c) precipitation occurs and the precipitated silica is recovered by filtration, washed of insoluble residuals and/or salts and dried later wherein the alkaline silicate is being produced via furnace process by use of waste foundry sand.

According to a more preferred embodiment of the present invention, wherein the alkaline silicate used for producing precipitated silica is sodium silicate and the mineral acid is sulfuric acid.

According to another embodiment of the present invention provides a method of producing precipitated silica, comprising the steps of:
a) providing an alkaline silicate solution comprising sodium silicate and water
b) adding sulfuric acid and sodium silicate solutions together with agitation
c) after precipitation, precipitated silica is recovered by filtration, washed of salts and dried later
wherein the sodium silicate material being produced via furnace process and by use of waste foundry sand (as described in the present invention and according to the above embodiments).

According to the present invention suitable amount of waste foundry sand is mixed with suitable amount of sodium carbonate via a lab size grinder (such as a coffee grinder) in order to homogenize the mixture. The mixture is then loaded into a graphite crucible to be heated in the melting furnace. The mixture is then heated up to 1150° C., for 1 to 3 hours. The melted mixture (waterglass) is then poured into a receiving crucible for cooling. The cooled waterglass is broken into small pieces with pressure and loaded into a pressure reactor with suitable amount of distilled water wherein the reactor has a agitor speed of 300 rpm and heated up to 185° C. for 1 to 2 hours. Finally the dissolved waterglass is filtered from the insoluble metal complexes and unreacted sand.

In a preferred embodiment, a phosphate material is added into the mixture of sand and alkali base. The phosphate material selected from the group, but not limited to, consisting of sodium phosphate, sodium tripolyphosphate (STTP), calcium phosphate, preferably sodium phosphate or sodium tripolyphosphate and any mixtures thereof, wherein the phosphate material reaches the phosphorus level of greater than ppm.

The present invention preferably relates to use of waste sand, more preferably use of waste foundry sand as a sustainable source for alkali metal silicate production.

The present invention preferably relates to use alkali metal silicate material, being produced waste sand or waste foundry sand, for production of precipitated silica.

### Metal and Phosphorus Determination Method

Metal and phosphorus concentrations are determined by use of Thermo i-Cap Q ICP/MS and Perkin Elmer Optima 8300 ICP/OES.

The sand sample is stabilized by heating 1.0 g of the sample with about 15 ml HCIO4 and 10 ml HF in a platinum dish until fumes are evolved. The platinum dish is cooled down and additional 5 ml HF is added and again heated to fumes. The dish is rinsed with DI water, then heated to fumes again. This solution is quantitatively transferred to a 100 ml volumetric flask and 1.0 ml Scandium standard solution is added and then diluted to mark with deionized water. Then 2.0 ml of this sample solution and 100 μL of (Ga, Ir, In, Y) mixture standard solution, are added to compensate for transport conditions, are diluted to 50 ml with water and aspirated into ICP.

The metal and phosphorus concentrations in the sample are determined by comparing the sample response to metal and phosphorus standards with known concentration.

### Molar Ratio Determination Method

Sodium silicate molar ratio is measured according to a Standard Evaluation Method as described below.

Sodium oxide and silica contents of sodium silicates are determined on the same samples by use of the volumetric method. The alkali in the sample is first determined in the usual manner by titration with hydrochloric acid. Then upon addition of an excess of sodium fluoride, a reaction occurs with the silicic acid present to form fluosilicate and sodium hydroxide. The alkali so liberated is titrated with standard acid, and the two titrations give a basis for calculating the sodium oxide and silica in the original sample.

### Color Measurement Method

Color measurement was done by scanning the absorbance within the visible range (400 nm to 700 nm) with HACH DR3900 spectrophotometer.

### Examples

The invention is further illustrated in detail hereinafter with reference to examples and comparative examples, without any intention to limit the scope of the present invention.

### Abbreviations

WFS: Waste Foundry Sand
WFS-CP
WFS-WF
CP and WF reflects to different sources available from various foundry sources
STTP: Sodium tripolyphosphate
DI: Distilled water

In the below examples, different waste foundry sands (WFS) have been used, such as without limitation to; WFS-CP or WFS-WF. These sands can be used either alone or a mixture thereof.

### Example Set 1: Reduction of Metal Impurities by Use of Waste Sand(s) Comparing to Virgin Sand

### Comparative Example 1

1. 100 g of virgin sand mixed with 53.3 g of sodium carbonate. The mixture is grinded with a grinder in order to homogenize the mixture. The mixture is then loaded into graphite crucible and put into the melting furnace. The mixture is heated to 1150° C. and for 1.5-2 hours.
2. After cooling the melted mixture of waterglass, 251 g of the waterglass is broken and dissolved within 700 g of distilled water in the pressure reactor. The mixture is heated up to 185° C. for 2 hours. The resultant mixture is then easily filtered to get the liquid sodium silicate.

TABLE 1
Reduction of Metal impurities in Virgin Sand

| | Virgin Sand 100% | |
|---|---|---|
| Metal | Remaining metal impurities in | |
| Impurities | Sodium Silicate after filtration | |
| P | <10 | ppm |
| CaO | 37 | ppm |
| Cu | 1.2 | ppm |
| MgO | <33 | ppm |
| Mn | 1.2 | ppm |
| Ni | 0.4 | ppm |
| Pb | 0.4 | ppm |

### Inventive Example 1 (a): Production of Waterglass via Fusion Process (100% CP Core blend)

3. 101 g of CP core sand mixed with 50.9 g of sodium carbonate. The mixture is grinded with a grinder in order to homogenize the mixture. The mixture is then loaded into graphite crucible and put into the melting furnace. The mixture is heated to 1150° C. and for 1.5-2 hours.
4. After cooling the melted mixture of waterglass, 254 g of the waterglass is broken and dissolved within 624 g of distilled water in the pressure reactor. The mixture is heated up to 185° C. for 2 hours. The resultant mixture is then easily filtered to get the liquid sodium silicate.

TABLE 1a
Reduction of Metal impurities based on inventive example 1(a)

| | Waste Foundry | | Remaining metal | | Insoluble metal | |
|---|---|---|---|---|---|---|
| | Sand 100% | | impurities in | | impurities/residues | |
| Metal | WFS-CP Core | | Sodium Silicate | | removed after | |
| Impurities | starting material | | after filtration | | filtration | |
| P | 29 | ppm | 16 | ppm | 414 | ppm |
| CaO | 430 | ppm | 97 | ppm | 1700 | ppm |
| Cu | 2.9 | ppm | 0.8 | ppm | 35.4 | ppm |
| MgO | 143 | ppm | 74 | ppm | 643 | ppm |
| Mn | 3.7 | ppm | 3.2 | ppm | 29.4 | ppm |
| Ni | 1.2 | ppm | 0.6 | ppm | 362.3 | ppm |
| Pb | 6.5 | ppm | 1.9 | ppm | 0.8 | ppm |

### Inventive Example 1 (b): Production of Waterglass Via Fusion Process (100% CP Core Blend)

1. 101 g of WFS-WF reclaimed sand mixed with 51.3 g of sodium carbonate. The mixture is grinded with a grinder in order to homogenize the mixture. The mixture is then loaded into graphite crucible and put into the melting furnace. The mixture is heated to 1150° C. and for 1.5-2 hours.
2. After cooling the melted mixture of waterglass, 258 g of the waterglass is broken and dissolved within 634 g of distilled water in the pressure reactor. The mixture is heated up to 185° C. for 2 hours. The resultant mixture is then easily filtered to get the liquid sodium silicate.

TABLE 1b
Reduction of Metal impurities based on inventive example 1(b)

| | Waste Foundry | | Remaining metal | | Insoluble metal | |
|---|---|---|---|---|---|---|
| | Sand 100% | | impurities in | | impurities/residues | |
| Metal | WFS-WF | | Sodium Silicate | | removed after | |
| Impurities | starting material | | after filtration | | filtration | |
| P | 43 | ppm | 34 | ppm | 36 | ppm |
| CaO | 737 | ppm | 176 | ppm | 7200 | ppm |
| Cu | 2.1 | ppm | 0.3 | ppm | 25.1 | ppm |
| MgO | 784 | ppm | 114 | ppm | 9200 | ppm |
| Mn | 70.7 | ppm | 17.1 | ppm | 566 | ppm |
| Ni | 1.4 | ppm | 0.4 | ppm | 39.6 | ppm |
| Pb | 1.9 | ppm | 0.4 | ppm | 4.5 | ppm |

### Inventive Example 1 (c): Production of Waterglass via Fusion Process (100% WFS-CP Core Scrap)

3. 103 g of WFS-CP core scrap sand mixed with 50.2 g of sodium carbonate. The mixture is grinded with a grinder in order to homogenize the mixture. The mixture is then loaded into graphite crucible and put into the melting furnace. The mixture is heated to 1150° C. and for 1.5-2 hours.
4. After cooling the melted mixture of waterglass, 254 g of the waterglass is broken and dissolved within 624 g of distilled water in the pressure reactor. The mixture is heated up to 185° C. for 2 hours. The resultant mixture is then easily filtered to get the liquid sodium silicate.

TABLE 1c
Reduction of Metal impurities based on inventive example 1(c)

| | Waste Foundry | | Remaining metal | | Insoluble metal | |
|---|---|---|---|---|---|---|
| | Sand 100% WFS- | | impurities in | | impurities/residues | |
| Metal | CP Core Scrap | | Sodium Silicate | | removed after | |
| Impurities | starting material | | after filtration | | filtration | |
| P | 35 | ppm | 21 | ppm | 188 | ppm |
| CaO | 701 | ppm | 48 | ppm | 4600 | ppm |
| Cu | 1.2 | ppm | 1.1 | ppm | 9.5 | ppm |
| MgO | 171 | ppm | 38 | ppm | 1600 | ppm |
| Mn | 6.8 | ppm | 5.1 | ppm | 31.4 | ppm |
| Ni | 10 | ppm | 1.5 | ppm | 121.3 | ppm |
| Pb | 1.8 | ppm | 1.1 | ppm | 1.1 | ppm |

As shown in the tables 1 (a-c) above, the presence of metal impurities in the sodium silicate and the remaining amount of insoluble metal impurities have been measured after filtration from the sodium silicate solution. The above tables 1 (a-c) show that the metal impurities are dramatically reduced when waste foundry sand is used and furnace process is applied. Considering that virgin sand comprises less metal impurities comparing to the waste sand or WFS, the data cannot be compared accordingly. The remaining metal impurities after filtration always depend on the sand (silicon dioxide source) being used in the mixture and waste foundry sand always comprises higher metal impurities at the beginning comparing to the virgin sand.

### Example Set 2: Comparison of Fusion Process with Hydrothermal Process (Wherein Virgin Sand is Mixed with WFS)

In both comparative and inventive examples, 20% of the virgin sand have been replaced with CP core waste foundry sand.

### Comparative Example 2: Production of Waterglass Via Hydrothermal Process (20% CP Core Blend is Mixed with Virgin Sand Based on Total Wt. Of Sand)

1. 378 g of distilled water and 448 g of 50% sodium hydroxide solution (Fisher Scientific) are mixed in a pressure reactor. 376 g of virgin sand and 96 g of CP core WFS is added into the liquid mixture. The agitator is set at 300 rpm and the mixture is heated to 192° C. (~ 150 psi) for 4 hours.
2. After cooling the melted mixture of waterglass, the resulting sodium silicate is filtered and washed the filtered resultant with 680 g water.

### Inventive Example 2: Production of Waterglass Via Fusion Process (20% CP Core Blend is Mixed with Virgin Sand Based on Total Wt. Of Sand)

1. 80 g of virgin sand (Silex 325, Covia) mixed with 20 g of CP core WFS and 51.5 g of sodium carbonate. The mixture is grinded with a grinder in order to homogenize the mixture. The mixture is then loaded into graphite crucible and put into the melting furnace. The mixture is heated to 1150° C. and for 1.5-2 hours.
2. After cooling the melted mixture of waterglass, 284 g of the waterglass is broken and dissolved within 615 g of distilled water in the pressure reactor. The mixture is heated up to 185° C. for 2 hours. The resultant mixture is then easily filtered to get the liquid sodium silicate.

TABLE 2
Comparison of Furnace Fusion Process with Hydrothermal
Process (by use of WFS blended with virgin sand)

| | Comparative Example 2 | | Inventive Example 2 | |
|---|---|---|---|---|
| | Hydrothermal Process | | Furnace Process | |
| *Sodium Silicate, Molar | 2.24 | | 3.28 | |
| Ratio (SiO₂/ Na₂O) | | | | |
| Metal impurities | Comparative Example 2 | | Inventive Example 2 | |
| P | 11 | ppm | 11 | ppm |
| CaO | 116 | ppm | 36 | ppm |
| Cu | 1.8 | ppm | 1.5 | ppm |
| MgO | 56 | ppm | 50 | ppm |
| Mn | 1 | ppm | 1.4 | ppm |
| Ni | 0.7 | ppm | 0.7 | ppm |
| Pb | 0.6 | ppm | 1.1 | ppm |

*Sodium Silicate molar ratio is calculated by the mole of SiO₂ / mole of Na₂O

Waste foundry sands usually comprise organic binders which are used in the sand molding process. As can be seen from the Table 2, during the hydrothermal process, wherein the achievable steam temperature is below 200° C. (in hydrothermal pressure reactor), the sands (both virgin and waste foundry sand) dissolved less than fusion process. Accordingly, the lower molar ratio of silicate is obtained via the hydrothermal process comparing to the fusion process.

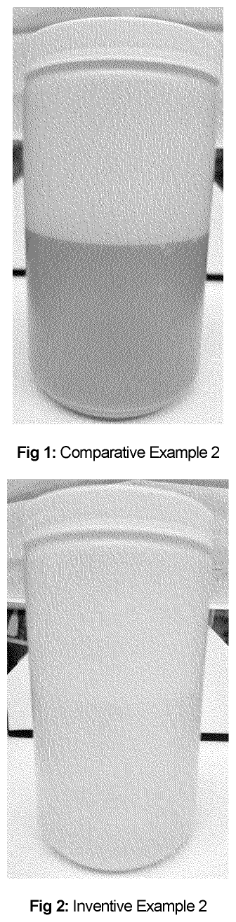

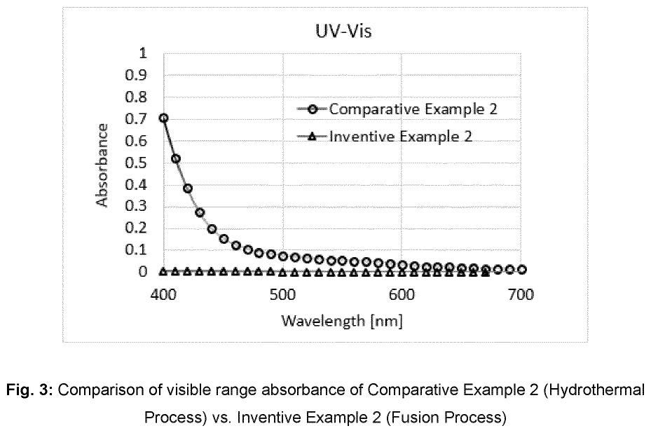

Furthermore, carbon species from waste foundry sand stay with the liquid silicate more comparing to the fusion process. The resulting silicate will contain less silica (low molar ratio silicate) and laced with carbon contamination which leads to a brown color after filtration. FIG. 1. shows the sodium silicate being produced via hydrothermal process under comparative example 2 and FIG. 2 shows the color of sodium silicate being produced via fusion process under inventive example 2. It is also obvious from FIG. 3 showing the visible range absorbance analytical data that the color absorbance is visible for the product being produced via hydrothermal process.

### Non Inventive Example Set 3: Use of Hydrothermal Process (Wherein Phosphate is Added into Waste Foundry Sand Mixed with Virgin Sand)

As mentioned in the body of the disclosure, phosphate materials have been suggested as possible additives to remove certain heavy metals, such as lead, from aqueous solutions (in hydrothermal processes) wherein virgin sand has been used as the silica source, as being disclosed in U.S. Pat. No. 7,297,318B2. Therefore, although use of phosphate materials for immobilizing lead and heavy metals has been suggested in the prior art, it creates a difficulty during filtering the silicate material when WFS is used in the hydrothermal process. Moreover, use of phosphate does not have much effect in reducing various metal impurities from the liquid state silicate as being shown in the below table 3.

### Example 3 (a): Production of Waterglass Via Hydrothermal Process by Use of Sand Mixtures

20% CP core blend is mixed with 80% of virgin sand based on total wt. of sand for waterglass production via hydrothermal process.

The procedure being defined in the Example 2 of U.S. Pat. No. 7,297,318 B2 patent is followed hereby. Two different phosphates (Hydroxyapatite, from Sigma-Aldrich and Sodium tripolyphosphate (STPP), from Fisher Scientific) are added separately into the sodium silicate solution. These two samples are tested for their efficacies in reducing metal impurities of silicate from liquid state process.

To 3 separate Teflon beakers, were added 100 g of the silicate solution from the above mixture. To two of the Teflon beakers, 1 g of hydroxyapatite or STPP were added, separately. These 3 samples were agitated with magnetic stir bar, heated and maintained between 70 to 75° C., on a hot plate. After 60 minutes, the mixtures were filtered with great difficulty with syringe (0.45 μm) filter warm. The resulted filtrates analyzed for the targeted metal impurities.

It is obvious from the below Table 3.1 that neither hydroxyapatite nor STPP have much effect in reducing the various metal impurities from liquid state silicate, other than Ni.

TABLE 3.1
Metal impurities after filtration

| | | | Comparative example | | Comparative | |
|---|---|---|---|---|---|---|
| Metal | Example | | 3 (a) with 1% | | example 3 | |
| impurities | 3 (a) | | hydroxyapatite | | (a) - 1% STPP | |
| P | 59 | ppm | 248 | ppm | 8400 | ppm |
| CaO | 77 | ppm | 121 | ppm | 78 | ppm |
| Cu | 1.0 | ppm | 1.7 | ppm | 1.0 | ppm |
| MgO | 32 | ppm | 29 | ppm | 34 | ppm |
| Mn | 1.0 | ppm | 0.9 | ppm | 1.0 | ppm |
| Ni | 1.7 | ppm | 0.7 | ppm | 0.5 | ppm |
| Pb | 0.7 | ppm | 0.7 | ppm | 1.1 | ppm |

### Example 3 (b): Production of Waterglass Via Hydrothermal Process (Phosphate is Added into the WFS)

100% CP core blend is used for waterglass production via hydrothermal process.

The same procedure is applied here as defined in example 3 (a). To 3 separate Teflon beakers, were added 100 g of the silicate solution provided above. To two of the Teflon beakers, 1 g of hydroxyapatite or STPP were added, separately. These 3 samples were agitated with magnetic stir bar, heated and maintained between 70 to 75° C., on a hot plate. After 60 minutes, the mixtures were filtered with great difficulty with syringe (0.45 μm) filter warm. The resulted filtrates analyzed for the targeted metal impurities.

It is obvious from the below Table 3.2 that neither hydroxyapatite nor STPP have much effect in reducing the various metal impurities from liquid state silicate, other than Mn.

TABLE 3.2
Metal impurities after filtration

| | | | Comparative example | | Comparative | |
|---|---|---|---|---|---|---|
| Metal | Example | | 3 (b) with 1% | | example 3 | |
| Impurities | 3 (b) | | hydroxyapatite | | (b) - 1% STPP | |
| P | 14 | ppm | 264 | ppm | 10200 | ppm |
| CaO | 25 | ppm | 31 | ppm | 26 | ppm |
| Cu | <0.1 | ppm | <0.1 | ppm | <0.1 | ppm |
| MgO | <33 | ppm | <33 | ppm | <33 | ppm |
| Mn | 2.9 | ppm | 0.8 | ppm | 2.1 | ppm |
| Ni | 1.7 | ppm | 2.1 | ppm | 4.6 | ppm |
| Pb | <0.1 | ppm | <0.1 | ppm | <0.1 | ppm |

The above examples 3 (a and b) and the corresponding Tables 3.1 and 3.2 show that the use of phosphate to remove the metal impurities in an aqueous solution (in hydrothermal process) do not help to reduce the metal impurity level after filtration even if it was the solution used before to reduce the metal impurities from aqueous solutions via hydrothermal process. It is obvious that phosphate addition into aqueous solution does not work with waste foundry sand if hydrothermal process is used.

1. A method of producing an alkali metal silicate material,
comprising:
a) providing a silicon dioxide source or mixtures thereof,
b) mixing said silicon dioxide source with an alkali base, selected from the group consisting of sodium carbonate, potassium carbonate, er lithium carbonate, and metal hydroxide,
c) heating the mixture at a temperature above 1000° C. for 1-5 hours,
d) dissolving resulting solid alkali metal silicate waterglass in water, and
e) removing any resultant insoluble heavy metal complexes and/or salts from said alkali metal silicate mixture, wherein the silicon dioxide source comprises a waste sand, mixtures thereof, or a mixture of waste sand with virgin sand.

2. The method according to claim 1, wherein said waste sand is a phosphate containing waste sand.

3. The method according to claim 1, wherein said waste sand is waste foundry sand.

4. The method according to claim 1, wherein said alkali base comprises sodium carbonate or sodium hydroxide.

5. The method according to claim 1, wherein said waste sand is introduced to said alkali base in an amount to create solid alkali metal silicate.

6. The method according to claim 1, wherein said waste sand is introduced to virgin sand in an amount from 20 wt. % to 80 wt. % based on the total weight of the sand.

7. The method according to claim 1, wherein the silicon dioxide source and alkali base mixture is heated to a temperature between 1000° C. to 1400° C. for 1-3 hours.

8. The method of producing an alkali metal silicate material according to claim 1, comprising:
a) providing said phosphate containing waste sand as the silicon dioxide source or mixtures thereof or a mixture of waste sand with virgin sand,
b) mixing said waste sand with a sodium carbonate,
c) heating the mixture at a temperature of 1150° C. for 1.5 to 2 hours,
d) dissolving resulting solid sodium silicate waterglass in water, and
e) removing any resultant insoluble heavy metal complexes and/or salts from said alkali metal silicate mixture wherein the phosphate containing waste sand is waste foundry sand (WFS).

9. A The method of producing an alkali metal silicate material according to claim 1, comprising:
a) providing a sand mixture,
b) mixing said sand mixture with sodium carbonate,
c) heating the mixture at a temperature of 1150° C. for 1.5 to 2 hours,
d) dissolving resulting solid sodium silicate waterglass in water, and
e) removing any resultant insoluble heavy metal complexes and/or salts from said alkali metal silicate mixture, wherein the sand mixture comprises 20 wt % to 50 wt % of phosphate containing waste sand and 50 wt % to 80 wt % of virgin sand based on the total weight of the sand.

10. The method according to claim 1, wherein the phosphate containing waste foundry sand has a phosphorus level of greater than 20 ppm.

11. The method according to claim 1, wherein an additional phosphate material is added into the mixture of sand and alkali base to reach the phosphorus level of greater than 30 ppm; wherein the phosphate material is selected from the group consisting of sodium phosphate, sodium tripolyphosphate (STTP), calcium phosphate, and any mixtures thereof.

12. A method of producing alkali metal silicate, comprising:
mixing waste sand as a sustainable source of silicon dioxide with an alkali base, and
heating the mixture.

13. The method of producing precipitated silica, comprising:
a) providing an alkaline silicate solution, comprising an alkali metal silicate and water,
b) adding sulfuric acid and alkaline silicate solutions together with agitation,
c) after precipitation, precipitated silica is recovered by filtration, washed of salts and dried later wherein the alkali metal silicate material being produced according to claim 1, via furnace process and by use of waste foundry sand.
